(19) United States
(12) Patent Application Publication
(10) Pub. No.: US 2013/0010756 A1
(43) Pub. Date: Jan. 10, 2013

(54) METHOD AND APPARATUS FOR SUPPORTING MOBILITY OF USER EQUIPMENT

(75) Inventors: Huarui LIANG, Beijing (CN); Hong WANG, Beijing (CN); Lixiang XU, Beijing (CN)

(73) Assignee: SAMSUNG ELECTRONICS CO. LTD., Suwon-si (KR)

(21) Appl. No.: 13/544,414

(22) Filed: Jul. 9, 2012

(30) Foreign Application Priority Data
Jul. 8, 2011 (CN) 201110193376.5

(51) Int. Cl. H04W 36/00

(52) U.S. Cl. 370/331

(57) ABSTRACT

A method and an apparatus for supporting mobility of a User Equipment (UE) are provided. When a UE moves into a Local Internet Protocol Access (LIPA)-enabled network or exits an LIPA-enabled network, the method is able to select an optimal user-plane node for the UE, provide optimal network routings and optimize network resource usage. For service continuity of the UE, when the UE performs remote access to an LIPA-enabled network from another network or when the UE moves into an LIPA-enabled network, the network re-selects an optimal user-plane node for the UE while keeping the remote service of the UE uninterrupted. When a UE moves from an LIPA-enabled network to another network, the network selects an optimal user-plane node for the UE while keeping the LIPA service uninterrupted. The method optimizes network resource usage and at the same time maintains the service quality perceived by the user.

### PRIORITY

This application claims the benefit under 35 U.S.C. §119(a) of a Chinese patent application filed in the State Intellectual Property Office of the People's Republic of China on Jul. 8, 2011 and assigned Serial No. 201110193376.5, the entire disclosure of which is hereby incorporated by reference.

### BACKGROUND OF THE INVENTION

1. Field of the Invention

The present invention relates to wireless telecommunications. More particularly, the present invention relates to a method and an apparatus for supporting mobility of a User Equipment (UE).

2. Description of the Related Art

FIG. 1 illustrates a structure of a System Architecture Evolution (SAE) system according to the related art.

Referring to FIG. 1, User equipment (UE) 101 is a terminal device for receiving data. Evolved-Universal Terrestrial Radio Access Network (E-UTRAN) 102 is a wireless access network which includes a macro base station (eNodeB/NodeB) providing a wireless network interface for UEs. Mobility Management Entity (MME) 103 manages mobility management context, session context and security information. Service GateWay (SGW) 104 mainly provides user-plane functions. MME 103 and SGW 104 may reside in the same physical entity. Packet data network Line GateWay (LGW) 105 provides functions including accounting, lawful monitoring and so on, and may reside in the same physical entity with SGW 104. Policy and Charging Rules Function (PCRF) 106 provides Quality of Service (QoS) policies and charging rules. Serving General Packet Radio Service (GPRS) Support Node (SGSN) 108 is a network node device for providing routings for data transmission in a Universal Mobile Telecommunications System (UMTS). Home Subscriber Server (HSS) 109 is a home subsystem of UEs, and maintains user information including current location, the address of a serving node, user security information, packet data context of a UE, and the like.

Along with increasing service data rate of UEs, operators adopt new techniques, such as a Selected Internet Protocol Traffic Offload (SIPTO) and a Local IP Access (LIPA). According to SIPTO, when a UE accesses the Internet or other public networks via a Home evolved NodeB (HeNB), a Home NodeB (HNB) or a macro NodeB (eNodeB/NodeB), the network is capable of selecting or re-selecting a user-plane node which is much closer to the wireless access network. When LIPA is performed, and the UE accesses a home network or an enterprise private network via an HeNB or an HNB, a user-plane node closer to the HNB or in the HeNB/HNB access network may be selected or re-selected for the UE. The user-plane node may be a core network device or a gateway, such as an SGW or a Packet data network GateWay (PGW) (Public Data Network (PDN) Gateway or Packet Gateway) or an LGW in a Long Term Evolution (LTE) system, or an SGSN or a Gateway GPRS Supporting Node (GGSN) in a UMTS system.

FIG. 2 illustrates a process of updating a user plane when service continuity is not supported according to the related art.

Referring to FIG. 2, when a UE accesses an LIPA service or an SIPTO service via a Local Area Network (LAN), the UE may be connected to a Public Data Network (PDN) via an LGW in a LAN. When the UE accesses the service via an eNodeB/NodeB or other types of HeNB, the operator network may select an SGW, which may reside in the same physical entity as an MME, and a PGW for connecting the UE with the PDN based on subscription information of the UE. If the UE is not in a local network and attempts to remotely access an enterprise network or a home network, the UE may access an LGW via a Virtual Private Network (VPN) and access the PDN via the LGW.

In the network shown in FIG. 2, when a UE moves into a home network or an enterprise network from another network, it is imperative to select an optimal LGW for the UE while keeping the service continuity. In addition, when a UE moves from an enterprise network or a home network to another network, it is also imperative to select a proper LGW while keeping the service continuity.

In the 3^{rd} Generation Partnership Project (3GPP) Release-10 (referred to as R-10 for short), at present there is no solution supporting LAN for SIPTO. As for LIPA in R-10, the network does not support continuity of LIPA services. Once a UE leaves a cell of an HeNB supporting LIPA, the LIPA service accessed by the UE will be interrupted.

In 3GPP Release-11 (R11 for short), operators need to support continuity of LIPA services, i.e., when a UE moves within a local network, service continuity of the UE needs to be guaranteed. Operators also need to support SIPTO service continuity, thus need a solution for enterprise networks and home networks. But there is currently no such solution in 3GPP.

Therefore, a need exists for a method and an apparatus for supporting mobility of a UE.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for supporting mobility of a User Equipment (UE).

When a UE moves between different networks, such as from a Local Internet Protocol Access (LIPA)/Selected Internet Protocol Traffic Offload (SIPTO)-enabled network to another network or from another network to an LIPA/SIPTO-enabled network, mobility of the UE can be guaranteed, and an optimal user-plane node can be selected for the UE to improve service experience and optimize network resource usage.

According to an aspect of the present invention, a method for supporting mobility of a user equipment is provided. The method includes keeping, by a UE, a connection with a packet data network Line GateWay (LGW) when the user moves out of an LIPA-enabled network or when the UE moves into an LIPA-enabled network.

According to another aspect of the present invention, an apparatus for supporting mobility of a UE is provided. The apparatus includes a transmitter, a receiver, and a controller for keeping a connection with an LGW when the UE moves out of a LIPA-enabled network or when the UE moves into an LIPA-enabled network, wherein the controller keeps an IP address of the UE unchanged when the UE moves out of the LIPA-enabled network, and keeps the IP address of the UE unchanged when the UE moves into the LIPA-enabled network from another network.

From the above analysis, it can be seen that an exemplary method of supporting mobility of a UE can select an optimal user-plane node for a UE when the UE moves to an LIPA/SIPTO-enabled network or leaves an LIPA/SIPTO-enabled network, provide optimal network routings, and optimize network resource usage. For service continuity of a UE, when the UE remotely accesses an LIPA/SIPTO-enabled network or when the UE moves into an LIPA/SIPTO-enable network, the remote service of the UE will not be interrupted, and the network can re-select an optimal user-plane node for the UE. When a UE moves from an LIPA/SIPTO-enabled network to another network, the LIPA/SIPTO service will not be interrupted, and the network can select an optimal user-plane node for the UE. The method optimizes network resource usage while guaranteeing user experiences.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a structure of a System Architecture Evolution (SAE) system according to the related art;

FIG. 2 illustrates a process of updating a user plane when service continuity is not supported according to the related art;

FIG. 3 illustrates a process of updating user plane when service continuity is supported according to an exemplary embodiment of the present invention;

FIG. 4A illustrates a network structure of a Long Term Evolution (LTE) system according to an exemplary embodiment of the present invention;

FIG. 4B illustrates a network structure of a Universal Mobile Telecommunications System (UMTS) system according to an exemplary embodiment of the present invention;

FIG. 4C illustrates a network structure of a UMTS system according to an exemplary embodiment of the present invention;

FIG. 5 is a flowchart illustrating a method for supporting mobility of a UE according to exemplary embodiment one of the present invention;

FIG. 6 is a flowchart illustrating a method for supporting mobility of a User Equipment (UE) according to exemplary embodiment two of the present invention;

FIG. 7 is a flowchart illustrating a method for supporting mobility of a UE according to exemplary embodiment three of the present invention;

FIG. 8 is a flowchart illustrating a process of a UE initiating access to a network according to an exemplary embodiment of the present invention;

FIG. 9 is a flowchart illustrating a process of S1 handover from a network to a Local Internet Protocol Access (LIPA)-enabled network according to an exemplary embodiment one of the present invention;

FIG. 10 is a flowchart illustrating a process of S1 handover from a network to an LIPA-enabled network according to exemplary embodiment two of the present invention;

FIG. 11 is a flowchart illustrating a process of X2 handover from a network to an LIPA-enabled network according to exemplary embodiment one of the present invention;

FIG. 12 is a flowchart illustrating a process of X2 handover from a network to an LIPA-enabled network according to exemplary embodiment two of the present invention;

FIG. 13 is a flowchart illustrating a process of X2 handover from an LIPA-enabled local network to another network according to an exemplary embodiment of the present invention;

FIG. 14 is a flowchart illustrating a method of location update according to an exemplary embodiment of the present invention;

FIG. 15 is a flowchart illustrating a method for supporting mobility of a UE according to an exemplary embodiment of the present invention;

FIG. 16 is a flowchart illustrating a method which does not support mobility of a UE according to an exemplary embodiment of the present invention;

FIG. 17 is a flowchart illustrating a method of re-selecting a new user-plane node for a UE according to exemplary embodiment one of the present invention;

FIG. 18 is a flowchart illustrating a method of re-selecting a new user-plane node for a UE according to exemplary embodiment one of the present invention;

FIG. 19 is a flowchart illustrating a process of a Mobility Management Entity (MME) in an LIPA-enabled network selecting a user-plane node for a UE according to an exemplary embodiment of the present invention; and

FIG. 20 is a block diagram illustrating a structure of a network node according to an exemplary embodiment of the present invention.

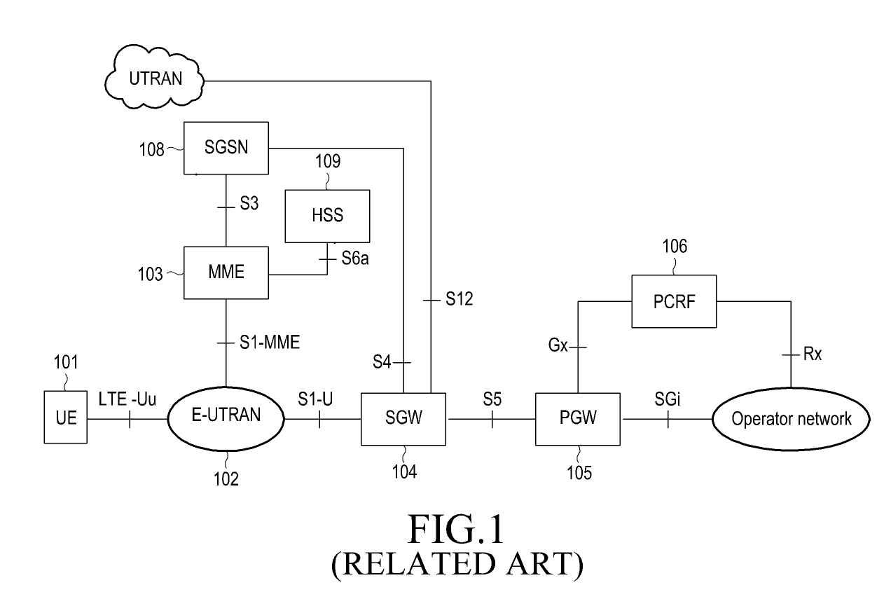

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In order to make the object, solution and merits of the present invention clearer, a detailed description of the present invention is hereinafter given with reference to specific exemplary embodiments and the accompanying drawings.

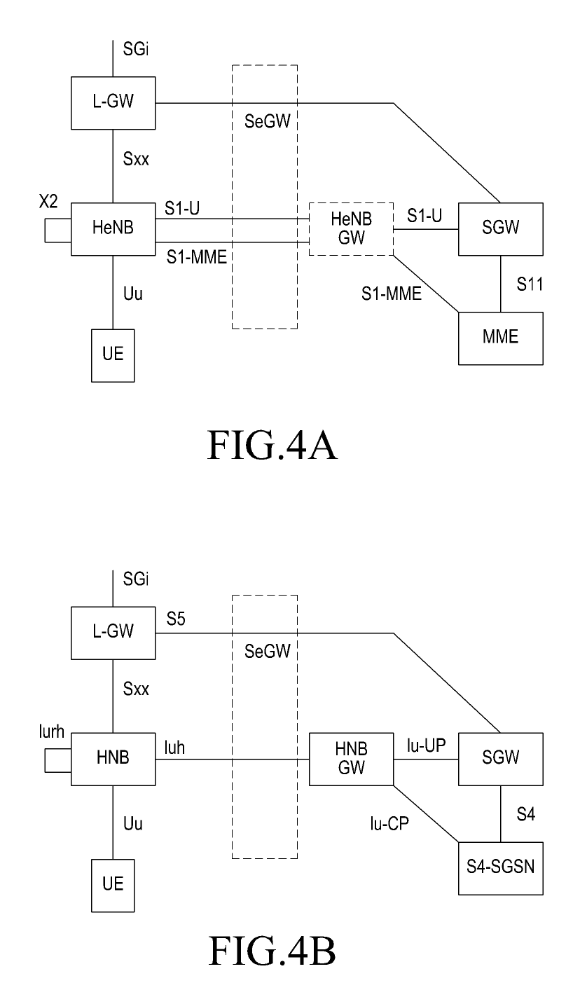

FIGS. 3 through 20, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 3 illustrates a process of updating user plane when service continuity is supported according to an exemplary embodiment of the present invention.

Referring to FIG. 3, when a User Equipment (UE) moves into a home network or an enterprise network from another network, an optimal Line GateWay (LGW) is selected for the UE while keeping the service continuity. The LGW supports a UE keeping the service continuity, when the UE moves from an enterprise network or a home network to another network.

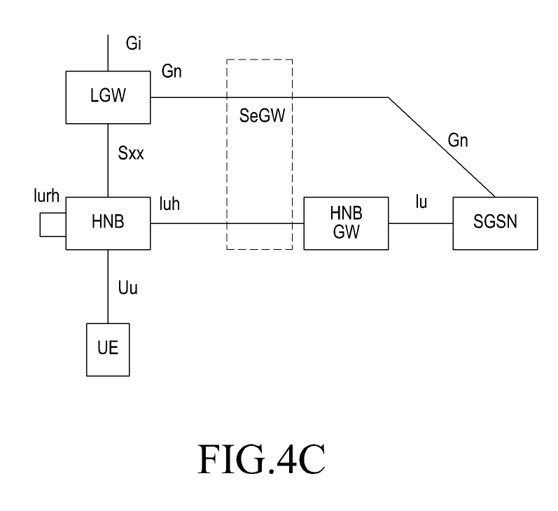

FIG. 4A illustrates a network structure of a Long Term Evolution (LTE) system according to an exemplary embodiment of the present invention. FIGS. 4B and 4C illustrate a network structure of a Universal Mobile Telecommunications System (UMTS) system respectively according to exemplary embodiments of the present invention.

Referring to FIGS. 4A through 4C, an interface between a Home evolved NodeB (HeNB) and an LGW is an Sxx interface which supports two types of protocol stacks. One type of the protocol stack enables the Sxx interface to support a General Packet Radio Service (GPRS) Tunneling Protocol for a User plane (GTP-U), and the other type of the protocol stack enables the Sxx interface to support both the GPRS Tunneling Protocol for Control plane (GTP-C) and the GTP-U. Methods of exemplary embodiments of the present invention include methods for supporting service continuity of a UE and methods not supporting service continuity of a UE. The above methods will be described in the following by taking the Long Term Evolution (LTE) system as an example.

### Exemplary Embodiment One

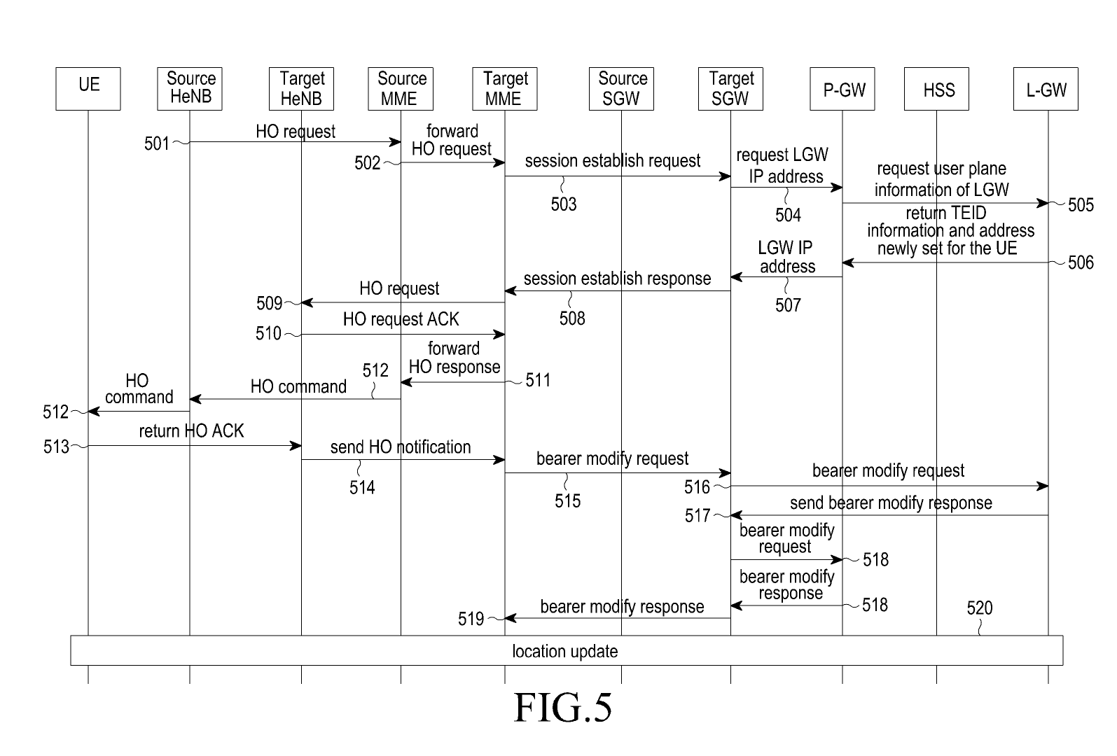

According to this exemplary embodiment, wherein the Sxx interface supports GTP-U, a UE supporting service continuity performs handover from an external network to the local network. An exemplary process is shown in FIG. 5.

FIG. 5 is a flowchart illustrating a method for supporting mobility of a UE according to exemplary embodiment one of the present invention.

Referring to FIG. 5, in block 501, a serving HeNB sends a handover request to a serving Mobility Management Entity (MME).

The handover request may include address information of a target HeNB, and may further include information of a target Local Home Network (LHN) ID. The handover request is for assisting the MME in determining whether the UE has entered the Local Internet Protocol Access (LIPA)-enabled local network. The serving HeNB may obtain the network information of the target HeNB from reports of the UE.

Alternatively, the serving HeNB may send LHN ID information of a local network where the serving HeNB is located to the MME via the handover request.

In block 502, the serving MME sends a forward handover request to a target MME.

The forward handover request may include MME UE context information. The forward handover request may include bearer information of the UE which may include information of an Access Point Name (APN), address information and tunnel information of a Packet data network GateWay (PGW) for uplink, and address information and tunnel information of a Service GateWay or Signaling GateWay (SGW) for uplink data transmission.

When the serving MME determines the current UE is to be handed over to the LIPA-enabled local network, new indication information is included into the forward handover request for indicating the target MME that the user plane needs to be switched to an LGW in the LIPA-enabled local network after the UE is handed over.

Alternatively, the serving MME may not perform the determination process, but sends the LHN ID of the serving HeNB to the target MME. The target MME sends a new request to the target HeNB for obtaining information of a network where the target HeNB currently locates (i.e., a target LHN ID). The target HeNB returns the current LHN ID according to the request. The target MME determines from the serving LHN ID and the target LHN ID whether the UE moves into the LIPA-enabled local network. When determining that the UE has moved into the LIPA-enabled local network, the target MME needs to switch the user plane of the UE to an LGW of the LIPA-enabled local network after the handover is completed.

In block 503, the target MME sends a session establish request to a target SGW.

The session establish request may include indication information indicating the UE is handed over to the LIPA-enabled local network. The indication information is used by the SGW subsequent when requesting a P-GW for address information of a target LGW.

The method takes a situation when SGW relocation is performed as an example. If the current SGW will not be changed after the handover, the target MME may send a message to a serving SGW after determining the UE will move into the LIPA-enabled local network. After receiving the message, the serving SGW may send a message to the PGW according to the new indication information. Subsequent process is the same with that of the present exemplary embodiment.

In block 504, the target SGW sends a new message to the PGW.

The message is for requesting IP address and tunnel ID information of the LGW. The message may be sent via a newly defined GTP-C message, or sent via existing GTP-C messages.

In block 505, the PGW requests the LGW for user plane information of the LGW.

After receiving the request, the LGW may allocate new Tunnel Endpoint IDentifier (TEID) information for the UE for uplink data transmission. The process of establishing a Virtual Private Network (VPN) between the PGW and the LGW is described via description of a remote access process of a UE.

In block 506, the LGW returns TEID information and an address newly set for the UE.

In block 507, the P-GW sends to the S-GW a response which may include the address information and the TEID information of the LGW for uplink data transmission of the UE.

In block 508, the target SGW sends a session establish response to the target MME.

The session establish response may include address information and tunnel information of the SGW, and may also include address information and tunnel information of the L-GW, because the S-GW needs to establish a single tunnel between an HeNB and the LGW when knowing the UE is to move into the LIPA-enabled local network.

In block 509, the target MME sends to the target HeNB a HandOver (HO) request which may include address information and tunnel information of the LGW for establishing the single tunnel.

In block 510, the target HeNB sends to the target MME an HO request ACKnowledgement (ACK) which may include address information and tunnel information of the HeNB for establishing downlink data transmission with the LGW.

In block 511, the target MME sends a forward handover request to the serving MME.

In block 512, the serving MME sends an HO command to the serving HeNB, and the serving HeNB sends the HO command to the UE.

In block 513, the UE returns an HO ACK to the target HeNB after receiving the HO command.

In block 514, the target HeNB sends an HO notification to the target MME.

In block 515, the target MME sends to the target SGW a bearer modify request which may include address information and tunnel information of the HeNB for establishing downlink data transmission with the LGW.

In block 516, the target SGW sends a bearer modify request to the LGW based on IP address information of the LGW previously obtained, and the bearer modify request may include address information and tunnel information of the SGW and address information and tunnel information of the HeNB.

The LGW may use the address information and tunnel information of the HeNB for downlink data transmission.

In block 517, the LGW sends a bearer modify response to the target SGW.

In block 518, the target SGW sends a bearer modify request to the PGW for updating current address information and tunnel information of the SGW in the PGW. After the update is completed, the PGW sends a bearer modify response to the target SGW.

In block 519, the target SGW sends a bearer modify response to the target MME.

The target MME initiates a de-activate process based on APN information of the LIPA network accessed by the UE to delete LIPA-related bearer information in the PGW to make the user plane route be from the HeNB to the LGW after the handover is completed.

In block 520, location update is performed after the handover is completed.

This procedure updates address information of the LGW in the Home Subscriber Server (HSS) after the handover. It should be noted that this procedure differs from the related art that the UE triggers the TAU process right away once the UE enters the LIPA-enabled local network. The UE may determine the UE has entered an LIPA-enabled local network based on broadcast messages sent by the HeNB.

Hence, the method for supporting mobility of a UE of the exemplary embodiment is completed.

### Exemplary Embodiment Two

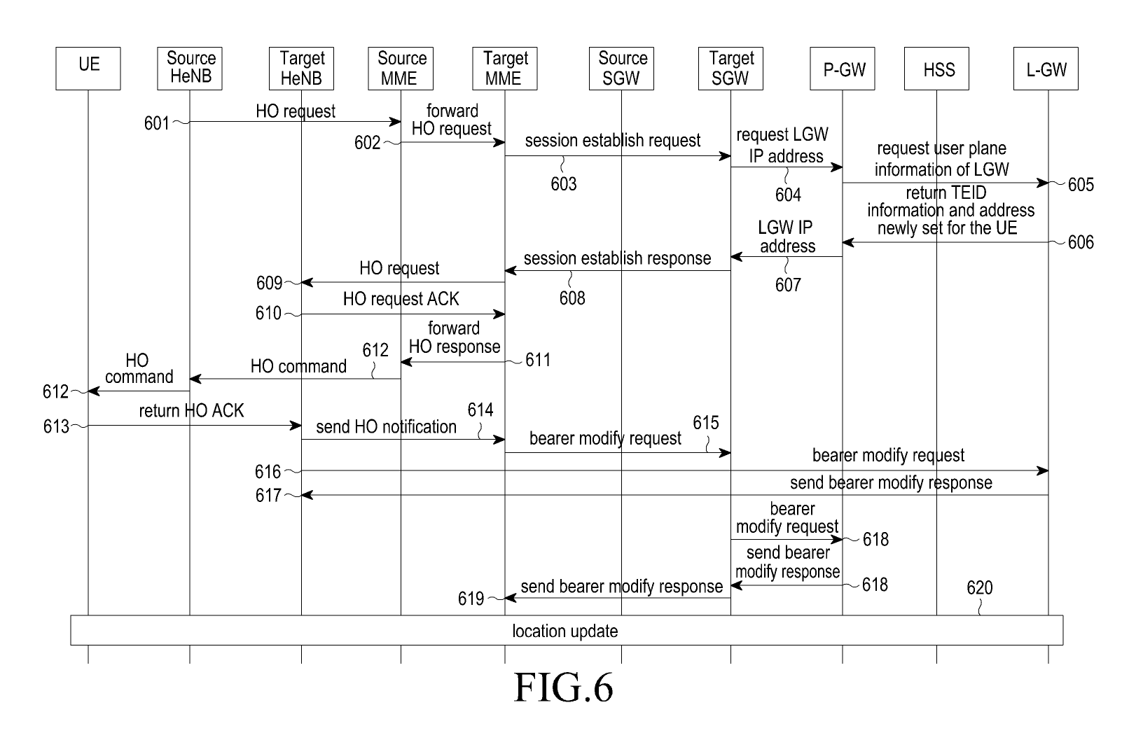

Similar to exemplary embodiment one, this exemplary embodiment is also applicable to a UE supporting service continuity to be handed over from an external network to a local network. But the Sxx interface of this exemplary embodiment supports both the GTP-C and the GTP-U, as shown in FIG. 6.

FIG. 6 is a flowchart illustrating a method for supporting mobility of a UE according to exemplary embodiment two of the present invention.

Referring to FIG. 6, procedures in blocks 601 to 615 are the same with that of blocks 501 to 515, thus will not be described further.

In block 616, the target HeNB directly sends a bearer modify request to the LGW. The bearer modify request may include address information and tunnel information of the HeNB for establishing downlink data transmission. In block 617, the LGW sends a bearer modify response to the HeNB. Procedures in blocks 618 to 620 are the same with that in blocks 518 to 520, and will not be described further. Hence, the method for supporting mobility of a UE of this exemplary embodiment is completed. It should be noted that in the above exemplary embodiments one and two, new parameters are added to existing handover signaling process to make uplink transmission route of the UE be from the HeNB to the LGW after the handover, and make downlink transmission route of the UE be from the LGW to the HeNB. Alternatively, new signaling messages may be adopted to make user plane route of the UE switch to the LIPA-enabled local network after the handover, and at the same time make the IP address of the UE still be allocated by the LGW and stay unchanged.

### Exemplary Embodiment Three

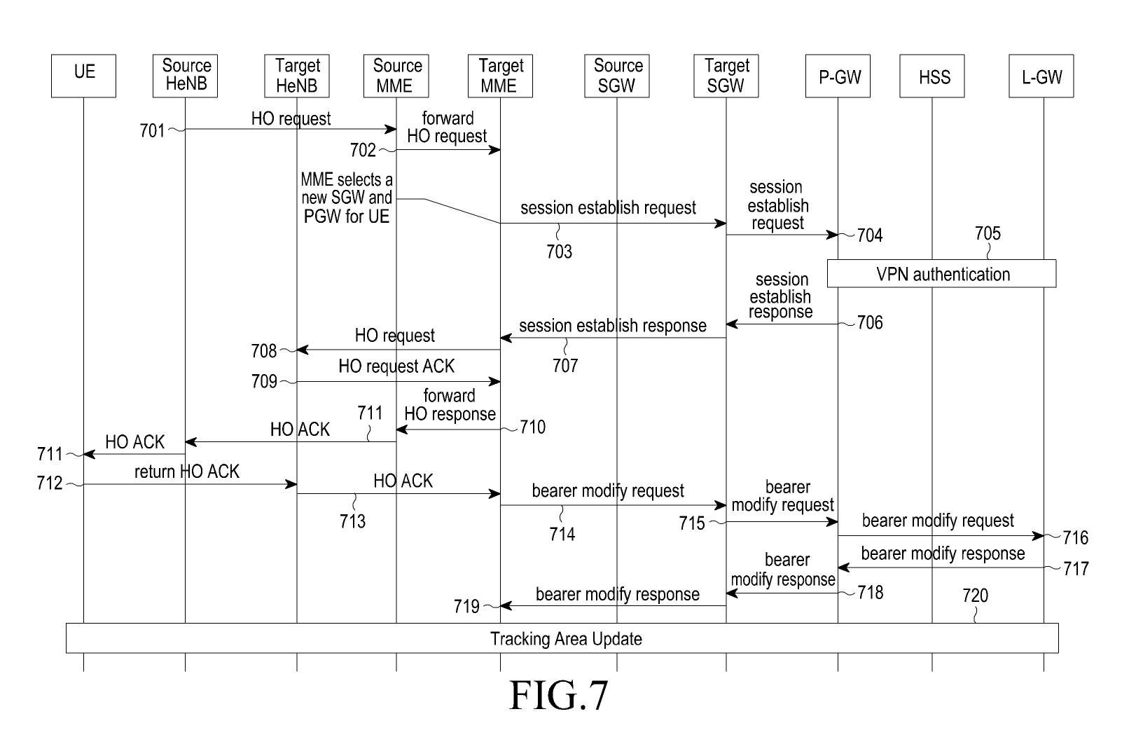

This exemplary embodiment applies to situations where a UE supporting service continuity is to be handed over from a local network to an external network. An exemplary process is shown in FIG. 7.

FIG. 7 is a flowchart illustrating a method for supporting mobility of a UE according to exemplary embodiment three of the present invention.

Referring to FIG. 7, in block 701, a serving HeNB sends a handover request to a serving MME. The handover request may include address information of a target HeNB, and may further include information of a target LHN ID. The handover request is for assisting the MME in determining whether the UE is to exit the LIPA-enabled local network. The serving HeNB may obtain the LHN ID information of the target network from reports of the UE.

In block 702, the serving MME sends a forward handover request to a target MME. The forward handover request may include MME UE context information. The MME UE context information may include bearer information of the UE. The bearer information may include information of an APN, address information and tunnel information of a PGW for uplink, and address information and tunnel information of an SGW for uplink data transmission.

When determining that the UE is to move from the LIPA-enabled local network to another network, the serving MME loads new indication information into the forward handover request to indicate the UE is to move to another network.

Alternatively, the target MME determines whether the UE is to move from an LIPA-enabled network to another network. The determination process is the same as that in blocks 601-602.

In block 703, the target MME selects a new SGW and a new PGW for the UE according to the indication information received. After the selection is done, the target MME sends a bearer establish request to a target SGW. An identifier for indicating the UE is to move to another network is added into the bearer establish request. The SGW sends a new message to the PGW according to the identifier instructing the PGW to establish a connection with the LGW previously accessed by the UE. The message may also include bearer information for uplink data transmission, such as address and tunnel information of the current LGW.

This method takes situations when SGW re-location is performed as an example. If the current SGW is not changed after the handover, the MME may be able to determine the UE is to move from the LIPA-enabled local network to another network and send a message to the serving SGW. After receiving the message, the serving SGW sends a message to the PGW according to the new indication information. Subsequent process is the same with that of the present exemplary embodiment.

In block 704, the target SGW sends to the PGW a session establish request which includes the address information and tunnel information of the LGW.

In block 705, the PGW performs authentication with the LGW for establishing a VPN based on the received address information of the LGW. The LGW may send an ACK to the PGW indicating the LGW can establish a VPN tunnel with the PGW for the UE when the authentication is passed.

In block 706, the PGW sends to the target SGW a session establish response, and allocates a new PGW address and tunnel information to the UE for uplink data transmission. The PGW informs the SGW of the address information and tunnel information of the PGW for uplink data transmission.

In block 707, the target SGW sends to the PGW a session establish request which includes the address information and tunnel information of the LGW.

In block 708, the MME sends an HO request to a target HeNB.

In block 709, the target HeNB sends to the MME an HO ACK which may include an Evolved Packet System (EPS) bearer list. Bearer information in each entry of the list may include address information and tunnel information of the HeNB for downlink data transmission.

In block 710, the target MME responds with a forward HO response.

In block 711, the MME sends an HO ACK to the NodeB, and the NodeB sends an HO ACK to the UE.

In block 712, the UE sends an HO ACK to the target HeNB.

In block 713, the target HeNB sends an HO ACK.

In block 714, the target MME sends a bearer modify request which may include address information and tunnel information of the HeNB for downlink data transmission.

In block 715, the SGW sends a bearer modify request to the PGW. The SGW allocates SGW tunnel information for the current bearer, and informs the PGW of the address information and tunnel information of the current SGW for downlink data transmission.

In block 716, the PGW sends a bearer modify request to the LGW. The PGW also allocates PGW tunnel information for the current bearer, and informs the LGW of the address information and tunnel information of the current PGW for downlink data transmission.

In block 717, the LGW sends a bearer modify response to the PGW.

In block 718, the PGW sends a bearer modify response to the SGW.

In block 719, the SGW sends a bearer modify response to the MME.

Procedure in block 720 is the same with that in block 520.

Hence, the method for supporting mobility of a UE of this exemplary embodiment is completed.

### Exemplary Embodiment Four

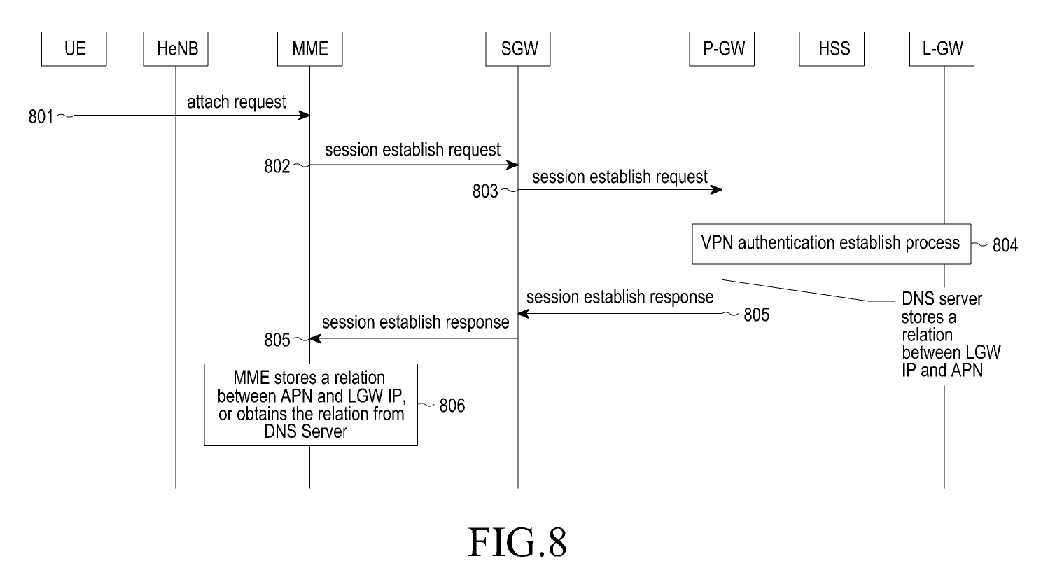

Similar to exemplary embodiment one, this exemplary embodiment may also be applicable to situations where the Sxx interface supports GTP-U, and a UE supporting service continuity is to be handed over from an external network to a local network. An exemplary process is shown in FIG. 8.

FIG. 8 is a flowchart illustrating a process of a UE initiating access to a network according to an exemplary embodiment of the present invention.

Referring to FIG. 8, in block 801, a UE sends an attach request to an MME.

In block 802, the MME sends to an SGW a session establish request which may include information, such as the APN which the UE requests to access. In block 803, the SGW sends a session establish request to a PGW. The PGW determines the UE requests a remote access based on the APN information.

In block 804, the PGW obtains the IP address of an LGW of the LIPA-enabled local network by communicating with a Domain Name System (DNS) server. The DNS server stores the APN information and IP address information of corresponding LGW. The PGW performs authentication of the current UE by communicating with an authentication server. The PGW establishes a VPN tunnel with the LGW, and stores the IP address of the LGW.

In block 805, the PGW sends a session establish response to the SGW, and the SGW sends to the MME a session establish response which may include the IP address of the LGW which is currently to be remotely accessed.

In block 806, the MME may store a relation which associates an APN with an IP address of the LGW based on the IP address of the LGW received. Furthermore, the relation which associates the APN with the LGW IP address may form part of the UE context.

If the message in this block does not include the IP address of the LGW, the MME may obtain the relation between the APN and the LGW address by communicating with the DNS server. Hence, the method for supporting mobility of a UE of this exemplary embodiment is completed.

It should be noted that this exemplary embodiment takes initial access process as an example, but the MME may also obtain the relation between the APN and the LGW from the process of establishing EPS bearer.

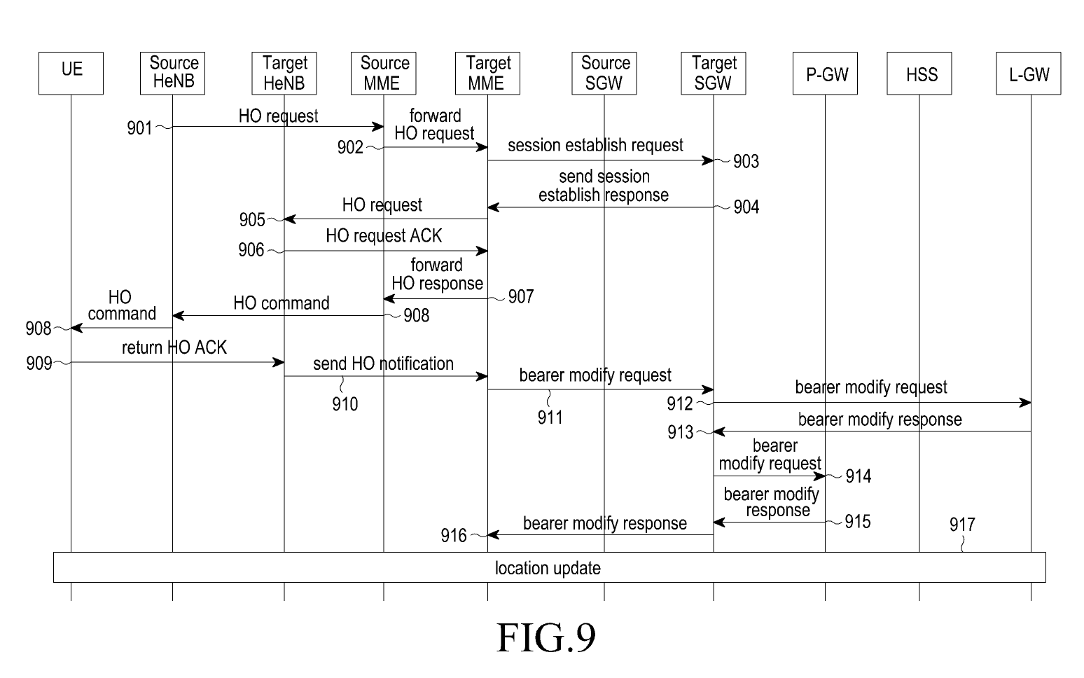

FIG. 9 is a flowchart illustrating a process of S1 handover from a network to a Local Internet Protocol Access (LIPA)-enabled network according to an exemplary embodiment one of the present invention.

Referring to FIG. 9, procedures in blocks 901 to 903 are the same with that of blocks 501 to 503, thus will not be described further.

In block 904, the target SGW sends a session establish request to a target MME. This process takes situations when SGW will be relocated as an example. If SGW relocation will not occur, procedures in blocks 703 to 704 can be omitted.

In block 905, the target MME sends to an HeNB an HO request which may include IP address and tunnel ID information of the LGW.

Since the MME stores the relation between the APN and the LGW, the MME determines the service is a remote accessed LIPA service based on the APN corresponding to the bearer of the current handover. Thereafter, the MME loads the IP address and tunnel ID information of the LGW into the HO request. The information is included in the bearer information supporting remote access in the EPS bearer list to be established.

Procedures in block 906-910 are the same with that in blocks 510-514.

In block 911, the target MME sends to the target SGW a bearer modify request which may include information, such as the IP address of the LGW.

Procedures in blocks 912 to 917 are the same with those in blocks 416 to 420.

Hence, the process of S1 handover from another network to an LIPA-enabled network of this exemplary embodiment is completed.

### Exemplary Embodiment Five

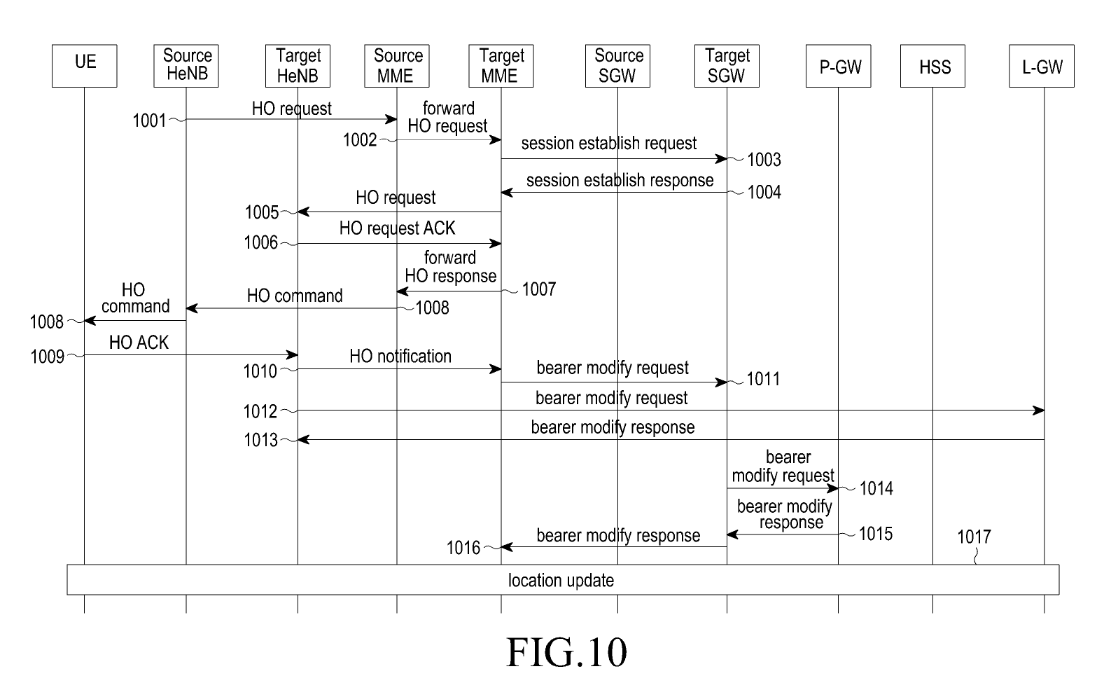

Similar to exemplary embodiment two, this exemplary embodiment may also be applicable to situations where the Sxx interface supports both the GTP-C and the GTP-U, and a UE supporting service continuity is to be handed over from an external network to a local network. An exemplary process is shown in FIG. 8, which illustrates a process of the UE performing initial access to the network as and FIG. 10, discussed below.

FIG. 10 is a flowchart illustrating a process of S1 handover from a network to an LIPA-enabled network according to exemplary embodiment two of the present invention.

Referring to FIG. 10, procedures in blocks 1001 to 1011 are the same with those in blocks 901 to 911.

In block 1012, the HeNB sends a bearer modify request to the LGW directly. The bearer modify request may include address information and tunnel information of the HeNB for establishing downlink data transmission.

In block 1013, the LGW sends a bearer modify response to the HeNB. Procedures in blocks 1014 to 1017 are the same with those in blocks 914 to 917. Hence, the process of S1 handover from another network to an LIPA-enabled network of this exemplary embodiment is completed.

### Exemplary Embodiment Six

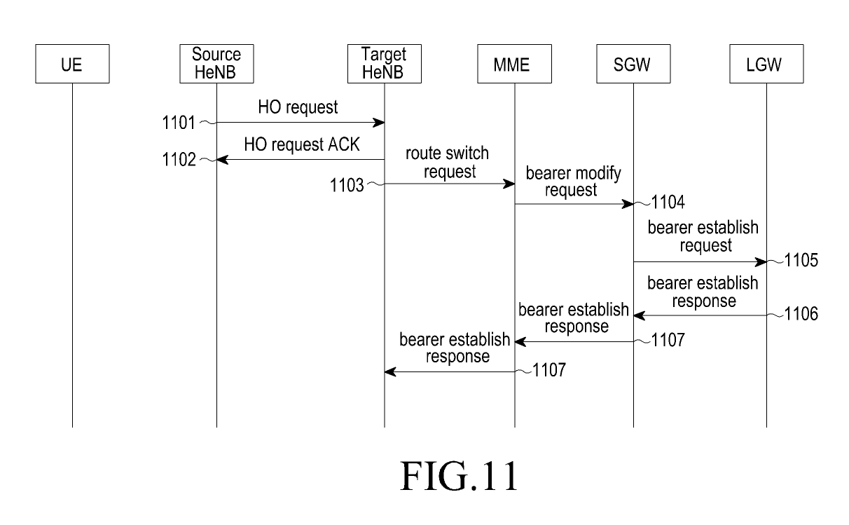

Similar to exemplary embodiment one, this exemplary embodiment may also be applicable to situations where the Sxx interface supports the GTP-U, the network supports service continuity, and a UE remotely accessing an LIPA-enabled local network from an external network is to be handed over to the local network. An exemplary process is shown in FIG. 8, which illustrates a process of a UE performing initial access to the network (remotely accessing the LIPA-enabled local network) and FIG. 11.

FIG. 11 is a flowchart illustrating a process of X2 handover from a network to an LIPA-enabled network according to exemplary embodiment one of the present invention. During the handover, if there is an X2 interface set between a target HeNB and a serving HeNB, FIG. 11 may specifically include the following procedures.

Referring to FIG. 11, in block 1101, a serving HeNB sends an HO request to a target HeNB.

The HO request may include ID information of the network supported by the serving HeNB. Since the target HeNB may have been configured with ID information of the local network, the target HeNB can determine whether the UE is moving from another network into the local network based on the network ID information in the HO request. The target Node B sends the result of the determination to an MME, for example, in block 1103.

Because the MME stores the APN from which the UE is accessing the service, the MME can determine whether the UE is moving from another network into the LIPA-enabled network after remotely accessing the LIPA service based on the APN stored and the determination result of the target HeNB.

The above is merely an exemplary manner for performing the determining process. The MME may also adopt other manners for determining whether the UE is moving from another network to the LIPA-enabled local network after remotely accessing the LIPA service.

In block 1102, the target HeNB sends an HO ACK to the serving HeNB.

In block 1103, the target HeNB sends to the MME a route switch request which may include network ID information of the current NodeB. The MME determines the UE is moving from another network to the LIPA-enabled network based on the information of the APN from which the UE is accessing the service and the network ID information corresponding to the APN. This method is an alternative to the determining manner in block 1101.

In block 1104, the MME sends to the SGW a bearer modify request which may include the IP address of the LGW.

The MME has stored a relation between the APN and an LGW IP, or obtains a relation between the APN and the LGW from the DNS server. The MME determines the handover is a handover of the local LIPA service based on the information of the APN of the current service handed over. If the service continuity of the remote access service is to be guaranteed after the handover, the MME loads the IP address of the LGW in the bearer modify request.

In block 1105, the SGW may send a bearer establish request to the LGW according to the indication information. The bearer establish request may include address information and tunnel information of the HeNB for downlink data transmission.

In block 1106, the LGW sends to the SGW a bearer establish response which may include address information and tunnel ID information of the LGW.

In block 1107, the SGW sends a bearer modify response to the MME, and sends address information and tunnel information of the LGW to the MME. The MME sends to the HeNB a route switch ACK which may include address information and tunnel information of the LGW for uplink data transmission.

Hence, the process of X2 handover from another network to an LIPA-enabled network of this exemplary embodiment is completed.

### Exemplary Embodiment Seven

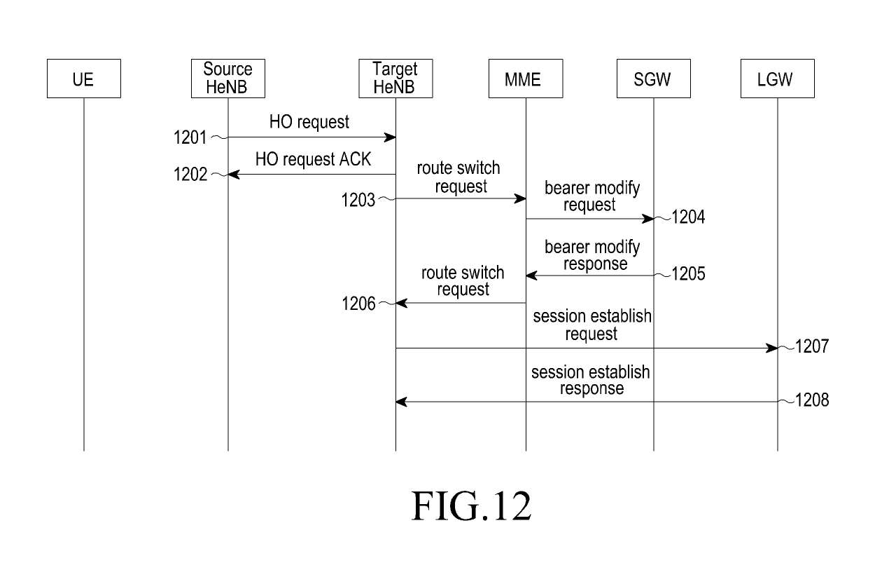

Similar to exemplary embodiment two, this exemplary embodiment may also be applicable for situations where the Sxx interface supports both the GTP-C and the GTP-U, the network supports service continuity, and a UE remotely accessing the LIPA-enabled network from an external network is to be handed over to the local network. An exemplary process is shown in FIG. 8, which illustrates a UE performing an initial access to the network and FIG. 12.

FIG. 12 is a flowchart illustrating an X2 handover process from another network to the LIPA-enabled network according to exemplary embodiment two of the present invention. During the handover, if there is an X2 interface set between a target HeNB and a serving HeNB, FIG. 12 may specifically include the following procedures.

Referring to FIG. 12, procedures in blocks 1201 to 1203 are the same with those in blocks 1101 to 1103.

In block 1204, the MME sends a bearer modify request to the SGW.

In block 1205, the SGW sends a bearer modify response to the MME.

Procedure in block 1206 is the same with that in block 1107.

In block 1207, an HeNB sends to the LGW a session establish request which may include address information of the HeNB for downlink data transmission based on address information of the LGW obtained.

In block 1208, the LGW sends a bearer establish response to the target HeNB. Hence, the process of X2 handover from another network to an LIPA-enabled network of this exemplary embodiment is completed.

### Exemplary Embodiment Eight

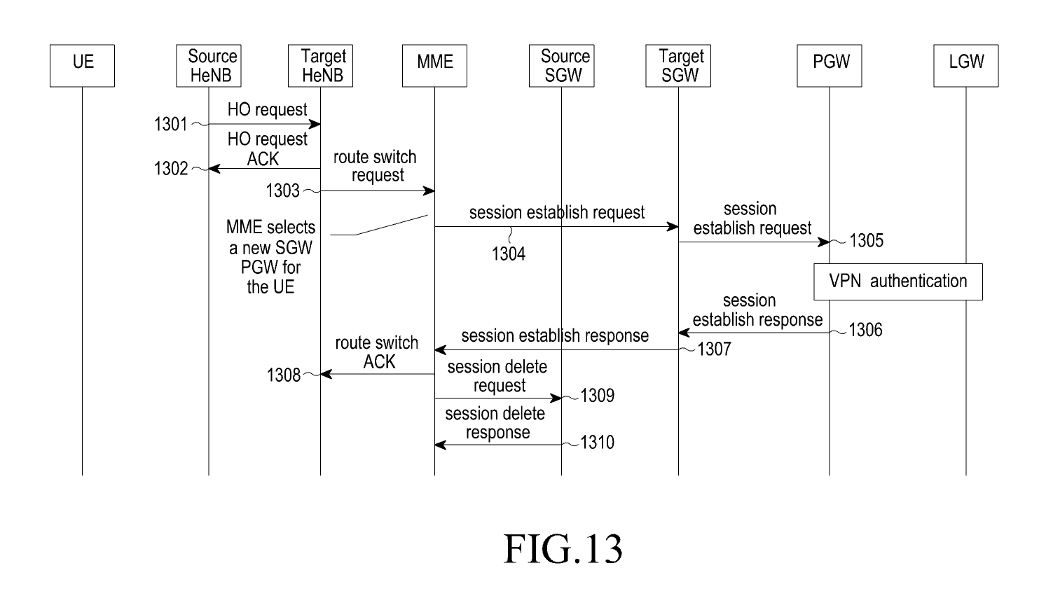

Similar to exemplary embodiment three, this exemplary embodiment is applicable to a network supporting service continuity and a UE to be handed over from a local network to an external network. During the handover, if an X2 interface is set between a target HeNB and a serving HeNB, the process is as shown in FIG. 13.

FIG. 13 is a flowchart illustrating a process of X2 handover from an LIPA-enabled local network to another network according to an exemplary embodiment of the present invention.

Referring to FIG. 13, procedures in blocks 1301 to 1303 are the same with those in blocks 1101 to 1103.

Procedures in blocks 1304 to 1307 are the same with those in blocks 704 to 707.

In block 1308, the MME sends a route switch ACK which may include address information of the SGW.

In block 1309, bearer information in the serving SGW is deleted.

In block 1310, the SGW sends an ACK to the MME after the bearer information is deleted. Hence, the X2 handover of this exemplary embodiment is completed.

It should be noted that in the above eight exemplary embodiments, location update will be performed after the handover is completed. Different from the related art, exemplary embodiments of the present invention enhance the conditions under which the UE may trigger the location update process, i.e., no matter whether the current location information of the UE is updated, once the UE detects the UE has moved into an LIPA-enabled local network or once the UE detects the UE has moved out of the LIPA-enabled local network, the UE triggers the location update process right away.

In this exemplary embodiment, the conditions for triggering the location update process may include the following aspects.

1. The UE determines that the UE has moved into an LIPA-enabled network. For example, the UE determines that the UE has moved into an LIPA-enabled local network from broadcast information of the current HeNB. In another aspect, during the handover, the UE is informed of the ID information of the LIPA-enabled local network via a handover ACK or other Radio Resource Control (RRC) messages.

2. The UE determines that the UE is moved out of an LIPA-enabled network. The UE may obtain network information of the HeNB currently accessed from broadcast information of the HeNB, or may obtain network information which is different from the local network information stored in the UE. For example, the UE stores an LIPA-enabled LHN ID information, and determines the UE has moved out of the LIPA-enabled network when the current HeNB does not broadcast any LHN ID information or the current HeNB broadcasts other LHN ID information. In another aspect, the UE obtains information of the current network from an HO ACK or other RRC messages received during the handover. The UE may determine the UE has moved out of the LIPA-enabled network by comparing the current network information with the LHN ID previously stored in the UE.

In the above blocks 512 and 711, the LHN ID of the target HeNB in the message is for use by the UE in determining whether the UE is still in the LIPA-enabled network.

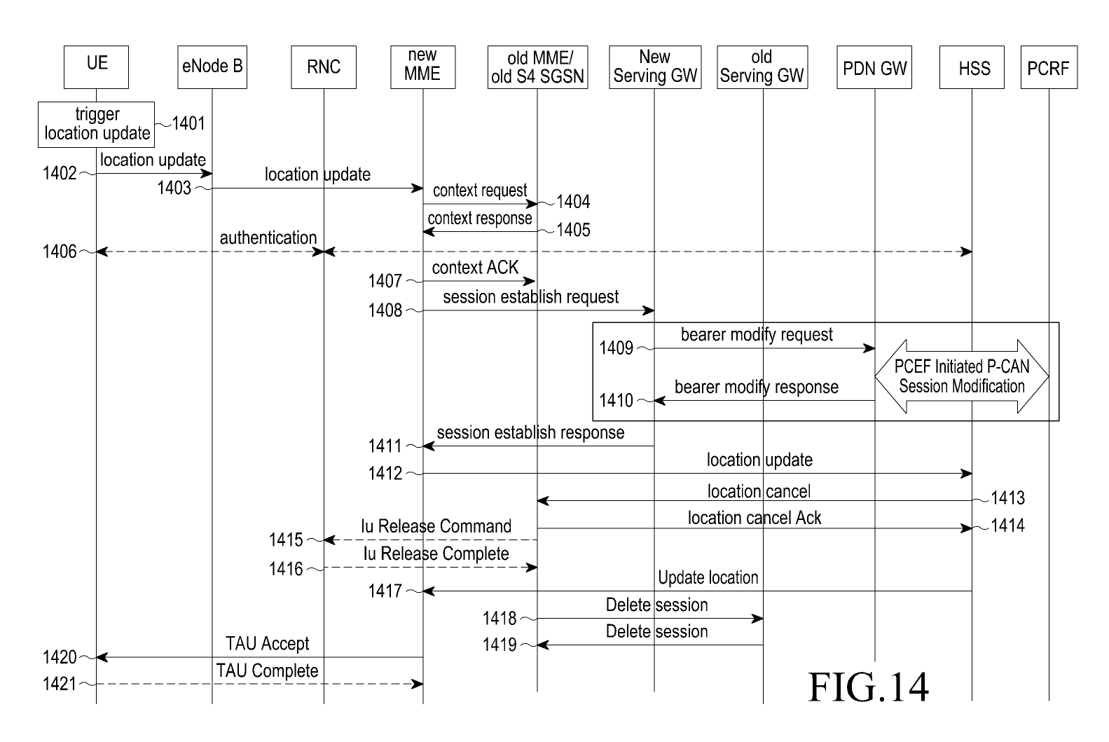

FIG. 14 is a flowchart illustrating a method of location update according to an exemplary embodiment of the present invention.

Referring to FIG. 14, in block 1401, the UE initiates a location update process based on the above conditions for triggering location update.

In blocks 1402 to 1403, the UE sends a location update request to the MME via eNodeB. The location update request may include a new identifier for instructing the MME to update the IP address of the current PGW in the Home Location Register (HLR). In another aspect, the MME may update the IP address of the PGW during subsequent interactions with the HSS based on the IP address of the new PGW obtained during the handover.

In block 1404, a new MME sends a context request to the serving MME.

In block 1405, the serving MME sends a context response to the new MME.

In block 1406, authentication for the UE is performed via a Radio Network Controller (RNC).

In block 1407, the new MME sends a context response to the serving MME.

In block 1408, the new MME sends a session establish request to a new SGW.

In block 1409, the new SGW sends a bearer modify request to the Public Data Network (PDN) GW.

In block 1410, the PDN GW sends a bearer modify response to the SGW.

In block 1411, the new SGW sends a session establish response to the new MME.

In block 1412, the MME sends to the HSS a location update message which may include the IP address of the new PGW. The HSS replaces previously stored IP address of the PGW with the IP address of the new PGW after receiving the location update message.

Other procedures (i.e., steps 1413 through 1421) in this exemplary embodiment are the same with that in the related art, thus will not be described further. Hence, the method of location update of this exemplary embodiment is completed.

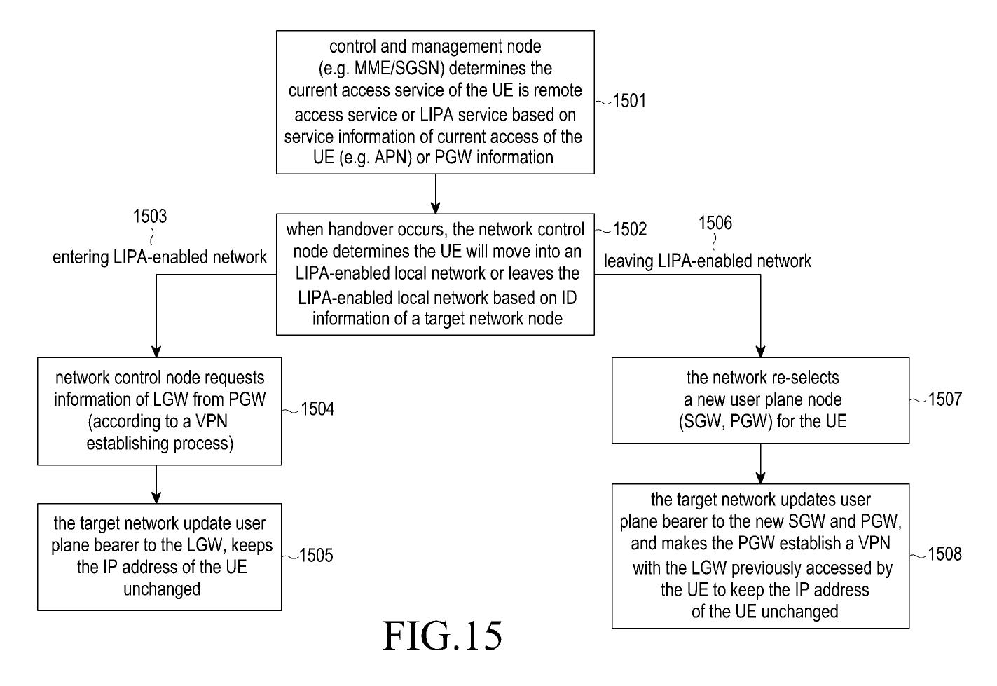

It should be noted that in the above exemplary embodiments, LGW address obtained by the MME or other network nodes during the handover or during the bearer establishing process is the IP address of the LGW in a device in the core network. After the handover, the user plane accesses the PDN via the LGW, so that the IP addresses allocated by the LGW to the UE before the handover and after the handover are the same. The above exemplary embodiments all guarantee the UE accesses the same PDN GW and has the same IP address allocated when the UE moves from an LIPA-enabled network to another network or moves from another network to the LIPA-enabled network, thus service continuity is guaranteed. FIG. 15 shows the detailed process.

FIG. 15 is a flowchart illustrating a method for supporting mobility of a UE according to an exemplary embodiment of the present invention.

Referring to FIG. 15, when LIPA connection or LIPA remote access is supported, as in step 1501, and when the UE moves, the network needs to determine, in step 1502, whether the UE is moving out of the LIPA-enabled network or is moving from another network into the LIPA-enabled network.

When the network determines the UE has changed the network it accesses, the network needs to perform re-selection of the user-plane node.

When the UE is moving from another network to the LIPA-enabled network, as in step 1503, a mobile control node makes the UE establish a connection with the same LGW previously remotely accessed by the UE when updating the user plane node, as in step 1504. After the handover is completed, the target network updates the user plane to the LGW to keep the IP address of the UE unchanged, as in 1505.

When the UE moves from an LIPA-enabled network to another network, as in step 1506, the mobile control node makes the UE establish a connection with the LGW through which the UE previously accessed the PDN when updating user plane node for the UE as in step 1507. After the handover, the new user plane node establishes a connection with the LGW to make the IP address of the UE unchanged as in step 1508.

### Exemplary Embodiment Nine

According to this exemplary embodiment, a network is able to determine a UE has moved into an LIPA-enabled network, or service continuity of a UE is not required when the UE moves out of the LIPA-enabled network.

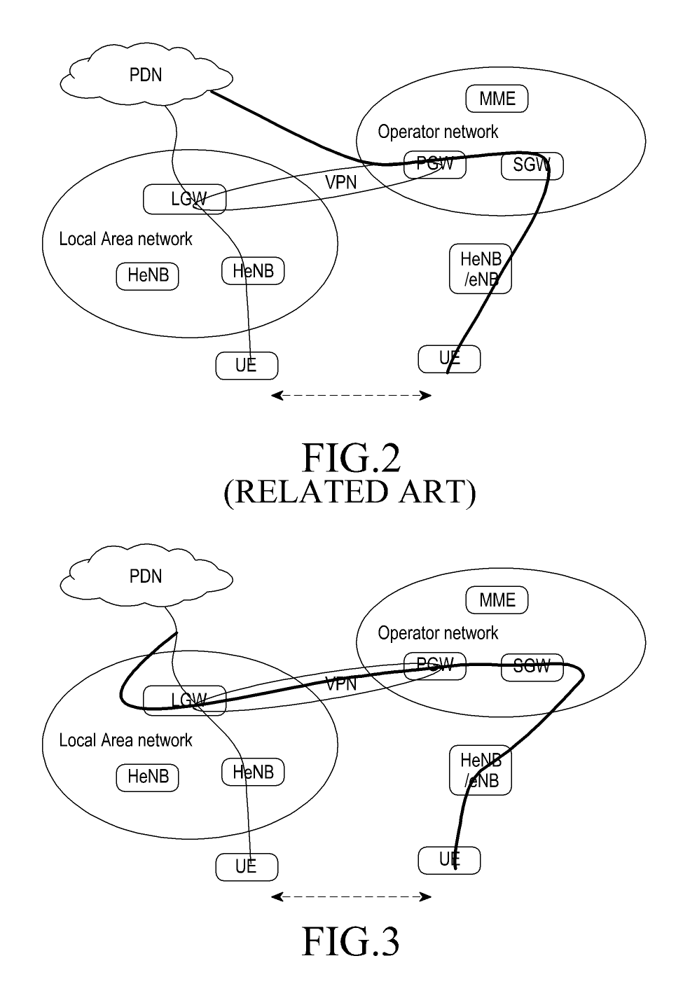

As shown in FIG. 2, when a UE moves out of an LIPA-enabled network, in order to select a proper SGW and a PGW, the gateway through which the UE accesses the PDN will not be the LGW to optimize network resource usage. When a UE moves into an LIPA-enabled local network from another network, an LGW in the local network is re-selected for the UE to optimize the network resource usage.

FIG. 2 is different from FIG. 3, as FIG. 3 is applicable for the above eight exemplary embodiments, a schematic illustrating a process of updating a user plane node when service continuity of a UE needs to be supported. When a UE moves from the LIPA-enabled local network into another network, the UE is made to access the PDN still via the previous LGW. When the UE remotely accesses the LGW from another network, when the UE moves from the another network into the LIPA-enabled local network, the UE is made to access the PDN through the previous LGW to support service continuity of the UE and to optimize network resource usage.

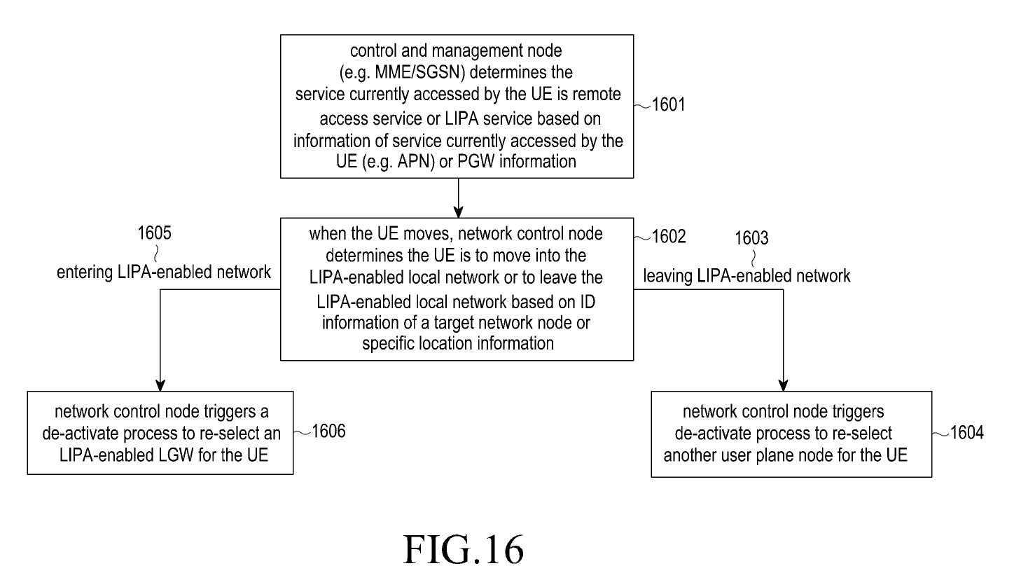

FIG. 16 is a flowchart illustrating a method which does not support mobility of a UE according to an exemplary embodiment of the present invention.

Referring to FIG. 16, when LIPA connection or LIPA remote access is supported, as in step 1601, and when the UE moves, the network needs to determine whether the UE is moving out of the LIPA-enabled network or is moving from another network into the LIPA-enabled network, as in step 1602.

When the network determines the UE has changed the network it currently accesses, the network needs to perform re-selection of the user-plane node. For example, when the UE moves out of the LIPA-enabled network, as in step 1603, re-selection of the SGW and the PGW should be supported, as in step 1604. When the UE moves into the LIPA-enabled local network, as in step 1605, selection of the LGW is performed, as in step 1606.

Specifically, if the UE is in the LIPA-enabled local network, the network needs to select an LGW for the UE.

When the UE moves from the LIPA-enabled local network to another network, the network needs to select an SGW and a PGW for the UE.

The following manners may be adopted for determining whether the UE is moving to another network.

Method 1: when preparing for the handover, the UE informs the serving HeNB of the network ID information of the target HeNB via a measurement report. The UE may obtain the network ID information of the target HeNB from broadcast information. For example, when the UE accesses an LIPA-enabled HeNB, the HeNB may broadcast ID information of the current network. The serving HeNB performs the determination based on network ID information of the serving HeNB and the received information.

The method of determining the UE is moving out of the LIPA-enabled network may be: determining the UE is to move out of the LIPA-enabled network when the network ID information is not identical or when failing to receive ID information of the target network.

The method of determining the UE is moving from another network to the LIPA-enabled network may be: roughly determining the UE may move into an LIPA-enabled network when the received information of the target network is not identical to the information of the current network.

Method 2: As in block 502, the MME determines whether the UE is moving from an LIPA-enabled network into another network or is moving from another network into an LIPA-enabled network based on information of the target network and information of the network currently accessed by the UE and information of the APN and so on.

Method 3: as in block 510, the MME determines whether the UE is moving out of an LIPA-enabled network or is moving into an LIPA-enabled network based on ID information of the current network obtained from the target HeNB.

According to the above exemplary methods, the network may determine the UE is moving to another network, and the MME may trigger a de-activate process of the current LIPA service or LIPA remote service to enable the UE to re-select a user plane node.

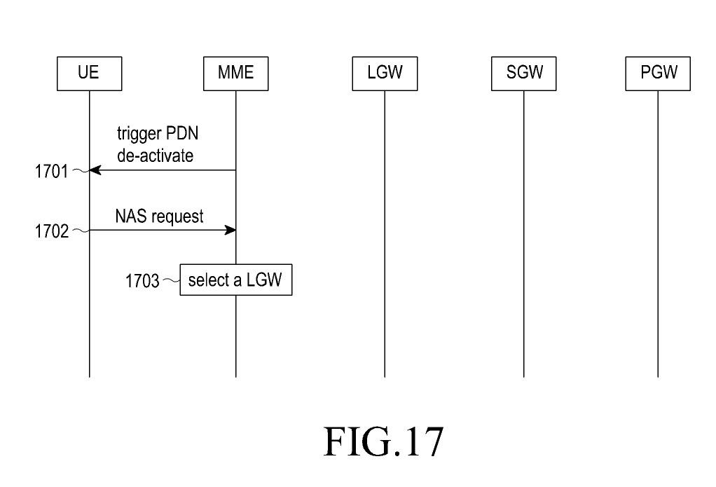

The method for re-selecting a user plane node for a UE may be as shown in FIG. 17.

FIG. 17 is a flowchart illustrating a method of re-selecting a new user-plane node for a UE according to exemplary embodiment one of the present invention.

Referring to FIG. 17, in block 1701, the MME may send to the UE a PDN de-activate message or another Non-Access Stratum (NAS) message which may include indication information for indicating the UE to initiate a re-connecting request.

In block 1702, the UE initiates a new NAS request according to the indication information. The NAS request may be a PDN connecting request or an attach request, or another NAS request.

In block 1703, the MME selects a new user plane node for the UE based on the request. The new user plane node may be a new SGW and PGW, or a new LGW.

Alternatively, the network node HeNB determines the UE has moved into another network, the HeNB sends a message via an interface connected with the LGW to instruct the LGW to initiate a PDN de-activate process. The MME may instruct the UE to re-send an NAS request, as in blocks 1701-1703.

According to the above exemplary embodiment in connection with location update process, the UE may determine the UE has moved into another network. The UE may initiate a NAS message to make the network select a new user plane node for the UE.

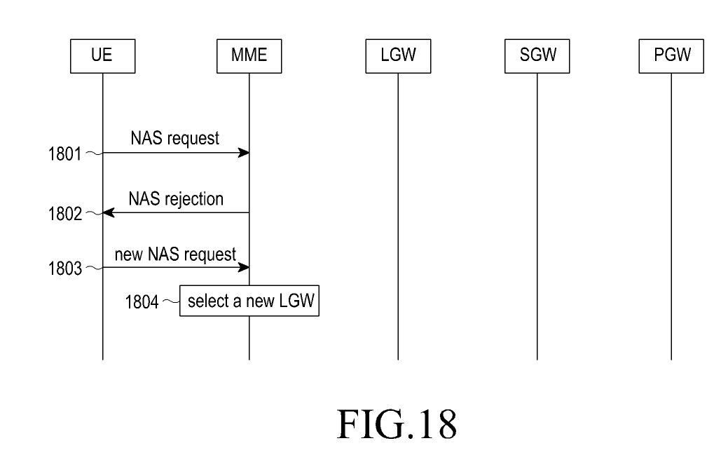

FIG. 18 is a flowchart illustrating a method of re-selecting a new user-plane node for a UE according to exemplary embodiment one of the present invention.

Referring to FIG. 18, in block 1801, the UE determines the UE has entered another network, and may initiate an NAS request to the MME. The NAS request may be a location update request, or a PDN connecting request, or a newly-defined NAS message.

In block 1802, the MME may determine that the UE needs re-selection of a user-plane node based on information of the HeNB which the UE requests to access and service information requested by the UE, and subscription information of the UE. The MME sends an NAS reject message to the UE.

In block 1803, the UE may send a new NAS request to the MME based on a NAS reject message or based on a service request of the UE.

In block 1804, the MME may select a new user-plane node for the UE.

The method of the MME selecting a new user-plane node for the UE may be as follows.

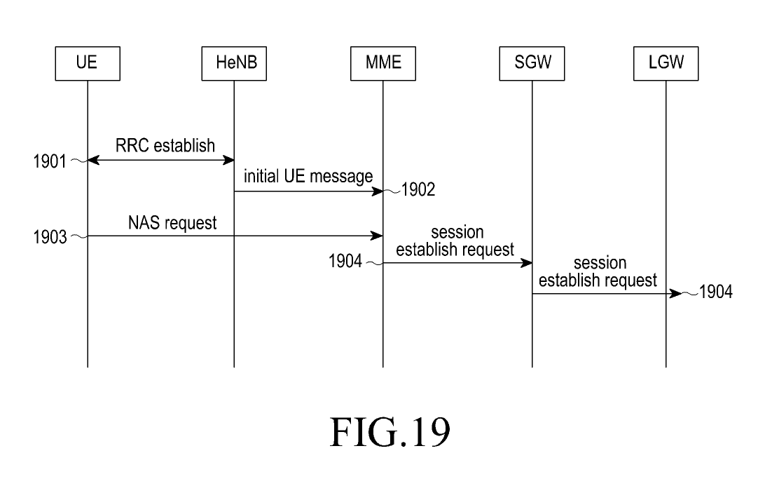

FIG. 19 is a flowchart illustrating a process of an MME in an LIPA-enabled network selecting a user-plane node for a UE according to an exemplary embodiment of the present invention.

Method 1 may include the following procedures. In block 1901, an RRC establishing process is performed.

In block 1902, an HeNB sends to an MME an initial UE message which may include capabilities of an LGW in the local network of the HeNB. The MME determines whether the LGW in the current network matches with the APN the UE requests to access based on the capabilities, which are optional.

If the capabilities of the LGW in the local network of the HeNB are not in the message, the MME may obtain the capabilities by interacting with a DNS. The DNS server stores capability information of an LGW in the network where the HeNB locates, and information of an APN matching the capability information. For example, the capability information of the LGW indicates the network where the LGW resides is a network supporting Selected Internet Protocol Traffic Offload (SIPTO) or LIPA. This information may be used by the MME in subsequent selection of LGW for the UE.

In block 1903, the UE sends an NAS request to the MME. The MME selects a proper LGW for the UE based on the APN in the NAS request. The MME may further perform the following determination based on subscription information of the UE (as shown in Table 1).

When determining the APN request is an LIPA request based on information of the APN the UE requested, the MME searches for an LIPA identity corresponding to the APN (LIPA access allowed). The MME may further determine whether the UE is a Closed Subscriber Group (CSG) member based on CSG subscription data.

If the UE is a CSG member, a proper LGW is selected for the UE according to the related art. The MME may obtain the relation between the APN and the LGW capabilities from the DNS server, or from an initial UE message which includes LGW capabilities sent by the HeNB to the MME, or from an initial UE message which includes capabilities of the network where the HeNB belongs sent by the HeNB to the MME. The network capabilities may include information about whether the current network allows a CSG member to access, or whether the current network is open for access by non-CSG members.

If the UE is not a CSG member, the MME may further determine whether other types of users are allowed to access services of the local network based on subscription information. If other types of users are allowed, the MME does not have to determine whether the current APN is in the CSG subscription information, and the MME selects a proper LGW for the UE based on a relation between the APN and the LGW. The MME may obtain the relation between the APN and the LGW capabilities from the DNS server, or from an initial UE message which includes LGW capabilities sent by the HeNB to the MME, or from an initial UE message which includes capabilities of the network where the HeNB belongs to and sent by the HeNB to the MME. The network capabilities may include information indicating that the current network is open for access by non-CSG members. Alternatively, the HeNB directly reports LGW which supports non-CSG members to the MME.

In the subscription information shown in Table 1, the newly added identity “allow accessing other types of HeNB to activate LIPA” may serve as an individual identity, or may be part of the identity “allow accessing LIPA”, or as part of the identity “allow accessing SIPTO”.

In block 1904, the MME sends a session establish request to a SGW which sends the session establish request to the LGW after a proper LGW is selected.

TABLE 1

| content | description |
|---|---|
| Access Point | an identity defined in DNS name collections, |
| Name (APN) | indicates the name of an access point connected |
| | to the PDN |
| CSG subscription | CSG subscription information is a list of a group |
| data | of CSG ID under each Visited Public Land |
| | Mobile Network (VPLMN). Each CSG ID has |
| | the same living time, and within the living time, |
| | the CSG ID is valid. If there is no corresponding |
| | living time, the information is subscription |
| | information which has not limit. |
| | Each CSG ID may access a specific PDN using a |
| | local IP. Each CSG ID has information of |
| | corresponding APN(s). |
| LIPA usability | indicating whether the UE is allowed to use |
| in VPLMN | LIPA service in this PLMN |
| SIPTO accessibility | indicating whether SIPTO is allowed for services |
| | of the current APN |
| LIPA accessibility | Indicates the current PDN provides local IP |
| | access. There are three corresponding |
| | parameters: LIPA not allowed, LIPA only and |
| | LIPA conditional. |
| LIPA accessibility | yes/no |
| via a non-CSG base | |
| station | |

Method 2: Existing subscription information does not have to be modified. The format of the existing subscription information is as shown in Table 1, excluding the last parameter in the table.

In block 1902, the HeNB sends to the MME an initial UE message which may include capability information of the network where the HeNB resides. The capability information may indicate whether the current network is open for accessing by non-CSG member users. The MME searches for an identity corresponding to the SIPTO in the subscription information based on the indication information.

The capability information of the network of the HeNB is optional. If the capabilities of the LGW in the local network of the HeNB are not in the message, the MME may obtain the capabilities by interacting with a DNS. The DNS server stores capability information of an LGW in the network where the HeNB locates, and information of an APN matching the capability information. For example, the capability information of the LGW indicates the network where the LGW resides is a network supporting SIPTO or LIPA. This information may be used by the MME in subsequent selection of LGW for the UE.

In block 1903, the UE sends an NAS request to the MME. The NAS request may include information of the APN to be accessed.

The MME selects a proper LGW for the UE based on the APN information and the SIPTO identity.

If the UE is a CSG member, the MME selects a proper LGW for the UE based on a relation between the APN and the LGW.

If the UE is a non-CSG member, the MME selects a proper LGW for the UE based on a relation between the APN and the LGW. The LGW selected by the MME for a non-CSG member may not be the same LGW selected for a CSG member.

The MME may obtain the relation between the APN and the LGW from the DNS. The DNS may store a relation which associates a UE, an APN, capability information of the network of an LGW and a CSG.

For example, the MME obtains the APN parameter from the NAS request from the UE, and instructs the UE to request access to the SIPTO-enabled local network. The MME may determine the UE is allowed to access SIPTO based on subscription information of the UE, and determines whether the UE is a CSG member. The MME requests the DNS to provide information of an LGW corresponding to information of the APN requested by the UE, ID information of the UE and information of the CSG. The DNS server stores a relation which associates the UE, the APN, capability information of the network of the LGW, the address of the LGW and the CSG and so on, so the DNS server may return the address of the LGW to the MME based on the relation. The MME selects a proper LGW for the UE.

The above takes situations when the HeNB does not provide capability information of the network where the LGW resides via an S1 interface as an example.

If the HeNB sends capability information of the network where the LGW resides via an S1 interface, the MME searches in subscription information of the UE for whether the UE is allowed to access SIPTO based on the information of the APN requested by the UE (e.g., the UE requests to access the SIPTO-enabled local network) and capability information of the network where the LGW resides (e.g., the network where the LGW connected with the current HeNB resides supports SIPTO local network). If the UE is allowed to access SIPTO, the MME directly selects an LGW corresponding to the SIPTO local network for the UE.

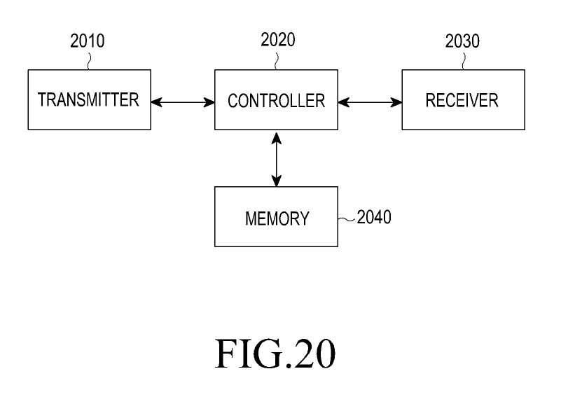

FIG. 20 is a block diagram illustrating a structure of a network node according to an exemplary embodiment of the present invention.

Referring to FIG. 20, the structure may be applied to at least one of a UE, an HeNB, an MME, an LGW, an SGW, and a PGW. A controller 2020 may control a transmitter 2010 and a receiver 2030 to communicate messages based on protocol stacks with other network node according to at least one of the above exemplary embodiments. A memory 2040 may store program codes executable in the controller 2020 and parameters required for prosecution of at least one of the above exemplary embodiments.

An exemplary embodiment of the present invention provides a method for supporting mobility of a UE. When a UE moves into an LIPA-enabled network or exits an LIPA-enabled network, the method is able to select an optimal user-plane node for the UE, provide optimal network routings and optimize network resource usage. For service continuity of the UE, when the UE performs remote access to an LIPA-enabled network from another network or when the UE moves into an LIPA-enabled network, the network re-selects an optimal user-plane node for the UE while keeping the remote service of the UE uninterrupted. When a UE moves from an LIPA-enabled network to another network, the network selects an optimal user-plane node for the UE while keeping the LIPA service uninterrupted. The method optimizes network resource usage while guaranteeing user experiences.

The foregoing are only preferred examples of the present disclosure and are not for use in limiting the protection scope thereof. All modifications, equivalent replacements or improvements in accordance with the spirit and principles of the present disclosure shall be included in the protection scope of the present disclosure.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for supporting mobility of a User Equipment (UE), the method comprising:
keeping, by a UE, a connection with a packet data network Line GateWay (LGW) when the UE moves out of a Local Internet Protocol Access (LIPA)-enabled network or when the UE moves into an LIPA-enabled network.

2. The method of claim 1, further comprising:
keeping an IP address of the UE unchanged when the UE moves out of the LIPA-enabled network; and
keeping the IP address of the UE unchanged when the UE moves into the LIPA-enabled network from another network.

3. The method of claim 2, further comprising:
switching, by a target Mobility Management Entity (MME), a user plane of the UE to an LGW of the LIPA-enabled network when the UE moves into the LIPA-enabled network from another network.

4. The method of claim 3, wherein the switching of the user plane of the UE to an LGW of the LIPA-enabled network comprises determining that the UE may move into an LIPA-enabled network when ID information of a target network is not identical to ID information of a current network.

5. The method of claim 2, further comprising:
selecting, by the LIPA-enabled network, a Signaling GateWay (SGW) and a Packet data network GateWay (PGW) for the UE when the UE moves from the LIPA-enabled network to another network.

6. The method of claim 5, wherein the selecting of the Signaling GateWay (SGW) and a Packet data network GateWay (PGW) for the UE comprises determining that the UE is to move out of the LIPA-enabled network when ID information of a current network is not identical with ID information of a target network or when failing to receive ID information of the target network.

7. The method of claim 2, wherein the method comprises:
requesting, by a Packet data network GateWay (PGW), the LGW to provide user plane information of the LGW;
returning, by the LGW, information of a Tunnel Endpoint Identifier (TEID) newly established for the UE and address information of the LGW;
sending, by the PGW to a target Signaling GateWay (SGW), a response which includes the address information and the TEID information of the LGW for uplink data transmission of the UE;
sending, by the target SGW, a bearer modify request to the LGW;
responding, by the LGW, a bearer modify response to the target SGW; and
sending, by a Mobility Management Entity (MME) to a Home Subscriber Server (HSS), a location update message which includes the address information of the LGW.

8. The method of claim 2, wherein the method comprises:
requesting, by a Packet data network GateWay (PGW), the LGW to provide user plane information of the LGW;
returning, by the LGW, information of a Tunnel Endpoint Identifier (TEID) newly established for the UE and address information of the LGW;
sending, by the PGW to a Signaling GateWay (SGW), a response which includes the address information and the TEID information of the LGW for uplink data transmission of the UE;
sending, by a target Home evolved NodeB (HeNB), a bearer modify request to the LGW;
responding, by the LGW, a bearer modify response to the target HeNB; and
sending, by a Mobility Management Entity (MME) to a Home Subscriber Server (HSS), a location update message which includes the address information of the LGW.

9. The method of claim 2, wherein the method comprises:
sending, by a target Signaling GateWay (SGW) to a Packet data network GateWay (PGW), a session establish request which includes the address information and tunnel information of the LGW;
performing, by the PGW, authentication with the LGW for establishing a Virtual Private Network (VPN) based on the address information of the LGW received;
returning, by the PGW to the target SGW, a session establish response which includes address information and tunnel information of the PGW;
sending, by a target Home evolved NodeB (HeNB), a bearer modify request to the PGW;
sending, by the PGW, a bearer modify request to the LGW;
responding, by the LGW, a bearer modify response to the HeNB; and
sending, by a Mobility Management Entity (MME) to a Home Subscriber Server (HSS), a location update message which includes the address information of the LGW.

10. The method of claim 2, wherein the method comprises:
storing, by a Mobility Management Entity (MME), a relation which associates an Access Point Name (APN) with an IP address of the LGW based on the IP address information of the LGW received;
sending, by a target Signaling GateWay (SGW), a bearer modify request to the LGW based on the IP address information of the LGW previously obtained;
sending, by the LGW, a bearer modify response to the target SGW; and
sending, by the MME to a Home Subscriber Server (HSS), a location update message which includes the address information of the LGW.

11. The method of claim 2, wherein the method comprises:
storing, by a Mobility Management Entity (MME), a relation which associates an Access Point Name (APN) with an IP address of the LGW based on the IP address of the LGW received;
sending, by a target Home evolved NodeB (HeNB), a bearer modify request to the LGW based on the IP address information of the LGW previously obtained;
sending, by the LGW, a bearer modify response to the target HeNB; and
sending, by the MME to a Home Subscriber Server (HSS), a location update message which includes the address information of the LGW.

12. The method of claim 2, wherein the method comprises:
storing, by a Mobility Management Entity (MME), a relation which associates an Access Point Name (APN) with an IP address of the LGW based on the IP address of the LGW received;
sending, by a target Signaling GateWay (SGW) to the LGW, a bearer establish request which includes address information and tunnel information of a Home evolved NodeB (HeNB);
sending, by the LGW, a bearer establish response to the SGW; and
sending, by a Mobility Management Entity (MME) to a Home Subscriber Server (HSS), a location update message which includes the address information of the LGW.

13. The method of claim 2, wherein the method comprises:
storing, by a Mobility Management Entity (MME), a relation which associates an Access Point Name (APN) with an IP address of the LGW based on the IP address of the LGW received;
sending, by a Home evolved NodeB (HeNB) to the LGW, a session establish request which includes address information of the HeNB;
sending, by the LGW, a bearer establish response to a target HeNB; and
sending, by the MME to a Home Subscriber Server (HSS), a location update message which includes the address information of the LGW.

14. The method of claim 2, wherein the method comprises:
storing, by a Mobility Management Entity (MME), a relation which associates an Access Point Name (APN) with an IP address of the LGW based on the IP address of the LGW received;
sending, by a target Signaling GateWay (SGW) to a Packet data network GateWay (PGW), a session establish request which includes address information and tunnel information of the LGW;
performing, by the PGW, authentication with the LGW for establishing a Virtual Private Network (VPN) based on the address information of the LGW received;
returning, by the PGW to the target SGW, a session establish response which includes address information and tunnel information of a new PGW allocated to the UE for uplink data transmission; and
sending, by a Mobility Management Entity (MME) to a Home Subscriber Server (HSS), a location update message which includes the address information of the LGW.

15. The method of claim 1, wherein the method comprises:
sending, by a Mobility Management Entity (MME) to the UE, a de-activate message or another Non-Access Stratum (NAS) message which includes indication information for indicating the UE to initiate a re-connecting request;
initiating, by the UE, a new NAS request according to the indication information;
selecting, by the MME, a new user-plane node for the UE based on the NAS request;
sending, by a Home evolved NodeB (HeNB), an initial UE message to the MME;
sending, by the UE, a NAS request to the MME; and
selecting, by the MME, a proper LGW and sending a session establish request to a Signaling GateWay (SGW) which sends the session establish request to the LGW.

16. The method of claim 1, wherein the method comprises:
sending, by the UE, a Non-Access Stratum (NAS) message to a Mobility Management Entity (MME);
determining, by the MME, the UE needs re-selection of a user-plane node based on information of the NodeB which the UE requests to access and information of service requested by the UE;
sending, by the UE, a new NAS request to the MME according to indication of a NAS reject message or based on service request of the UE;
selecting, by the MME, a new user-plane node for the UE;
sending, by a Home evolved NodeB (HeNB), an initial UE message to the MME;
sending, by the UE, a NAS request to the MME; and
selecting, by the MME, a proper LGW and sending a session establish request to a Signaling GateWay (SGW) which sends the session establish request to the LGW.

17. An apparatus for supporting mobility of a User Equipment (UE), the apparatus comprising:
a transmitter;
a receiver; and
a controller for keeping a connection with a packet data network Line GateWay (LGW) when the UE moves out of a Local Internet Protocol Access (LIPA)-enabled network or when the UE moves into an LIPA-enabled network,
wherein the controller keeps an IP address of the UE unchanged when the UE moves out of the LIPA-enabled network, and keeps the IP address of the UE unchanged when the UE moves into the LIPA-enabled network from another network.
